(19) United States
(12) Patent Application Publication
(10) Pub. No.: US 2026/0225802 A1
(43) Pub. Date: Aug. 6, 2026

(54) AUTOMATIC TRANSPORT DEVICE

(71) Applicant: Sharp Kabushiki Kaisha, Sakai City (JP)

(72) Inventor: Atsushi NAKAMOTO, Sakai City (JP)

(21) Appl. No.: 19/444,369

(22) Filed: Jan. 9, 2026

(30) Foreign Application Priority Data
Feb. 6, 2025 (JP) 2025-018038

(51) Int. Cl. B65G 1/04; B66F 9/06; B66F 9/07; B66F 9/18; G05D 1/667; G05D 107/70

(52) U.S. Cl. CPC B65G 1/0435; B66F 9/063; B66F 9/07; B66F 9/181; G05D 1/667; G05D 2107/70

(57) ABSTRACT

An automatic transport device 1 includes a holder 28 that has a slide surface 28a and holds a transport target object 6 on the slide surface 28a so as to be slidable in a front-rear direction, rails 20x and 20y disposed on the slide surface 28a, a base 22 connected to the rails 20x and 20y so as to be movable in the front-rear direction above the slide surface 28a, a drive motor 24 that slides the base 22 along the rails 20x and 20y, an extendable mechanism 23 that is disposed on the base 22 and is extendable outward from an end portion of the slide surface 28a in the front-rear direction, and a coupler 21 that is disposed at a distal end of the extendable mechanism 23 and coupled to a side surface of the transport target object 6.

### INCORPORATION BY REFERENCE

This application is based upon and claims the benefit of priority from the corresponding Japanese Patent Application No. 2025-018038 filed on February 6, 2025, the entire contents of which are incorporated herein by reference.

### BACKGROUND

The present disclosure relates to an automatic transport device transporting a transport target object.

Automatic transport devices that take articles (transport target objects) off storage shelves and transport same to predetermined positions (such as shipping areas) in warehouses or the like have been heretofore known. For example, there is known a transport robot including a transport arm assembly to which a hook is slidably connected. The transport robot causes the transport arm assembly to linearly reciprocate, and pushes out an article placed on the transport arm assembly or moves the article onto the transport arm assembly by linearly reciprocating the hook on the transport arm assembly.

However, the conventional technique is configured such that a transport arm assembly itself including a slide surface on which a transport target object is to be placed moves so as to face the transport target object, and after a hook positioned at a distal end of the transport arm assembly is hooked on the transport target object, the hook is retracted to pull the transport target object onto the slide surface. Therefore, for example, when the transport target object is disposed (stored) in a place away from the transport arm assembly, the transport target object cannot be accessed and cannot be moved onto the transport arm assembly. Furthermore, when the storage place for storing the transport target object is narrower than a lateral width of the transport arm assembly, the transport arm assembly cannot be moved (inserted) into the storage place, and thus the transport target object cannot be moved onto the transport arm assembly.

### SUMMARY

An object of the present disclosure is to provide an automatic transport device capable of transporting a transport target object disposed at a location away from a slide surface on which the transport target object is to be mounted.

An automatic transport device according to one aspect of the present disclosure transports a transport target object to a predetermined location. The automatic transport device includes a holder that has a slide surface and holds the transport target object on the slide surface so as to be slidable in a first direction, a rail disposed on the slide surface, a base connected to the rail so as to be movable in the first direction above the slide surface, a first driver that slides the base along the rail, an extendable mechanism that is disposed on the base and that is extendable outward from an end portion of the slide surface in the first direction and extendable in the first direction, and a coupler that is disposed at a distal end of the extendable mechanism and coupled to a side surface of the transport target object.

According to the present disclosure, an automatic transport device capable of transporting a transport target object disposed at a location away from a slide surface on which the transport target object is to be placed can be provided.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a side view illustrating an entire configuration of an automatic transport device according to an embodiment of the present disclosure.

FIG. 2 is a front view illustrating the entire configuration of the automatic transport device according to the embodiment of the present disclosure.

FIG. 3 is a diagram illustrating the automatic transport device according to the embodiment of the present disclosure and a storage shelf.

FIGS. 4A to 4D are diagrams illustrating an example of a picking method executed by the automatic transport device according to the embodiment of the present disclosure.

FIG. 5 is a top view illustrating a configuration of a transfer device according to the embodiment of the present disclosure.

FIG. 6 is a side view illustrating the configuration of the transfer device according to the embodiment of the present disclosure.

FIG. 7 is a diagram illustrating a picking method in the transfer device according to the embodiment of the present disclosure.

FIG. 8 is a diagram illustrating the picking method in the transfer device according to the embodiment of the present disclosure.

FIG. 9 is a diagram illustrating the picking method in the transfer device according to the embodiment of the present disclosure.

FIG. 10 is a diagram illustrating the picking method in the transfer device according to the embodiment of the present disclosure.

FIG. 11 is a diagram illustrating a configuration of a coupler according to another embodiment of the present disclosure.

FIG. 12 is a diagram illustrating a configuration of the coupler according to the other embodiment of the present disclosure.

### DETAILED DESCRIPTION

Hereinafter, embodiments of the present disclosure will be described with reference to the accompanying drawings for understanding of the present disclosure. Note that the following embodiments are merely embodied examples of the present disclosure, and do not limit the technical scope of the present disclosure.

### Automatic Transport Device 1

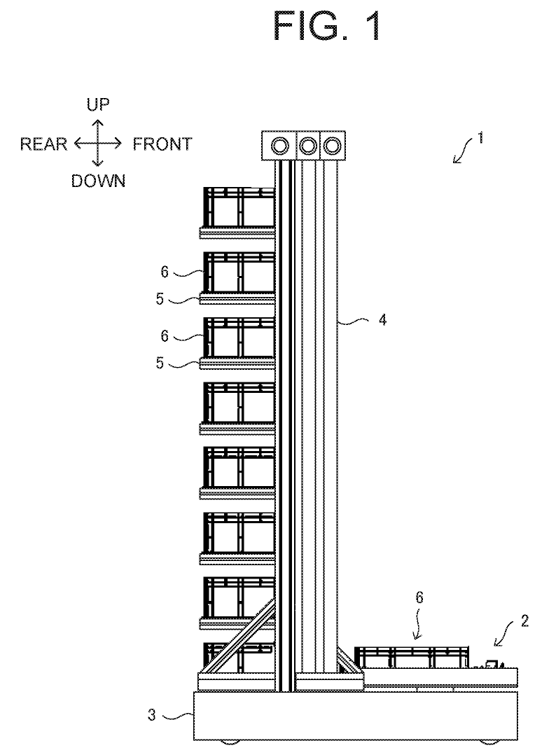

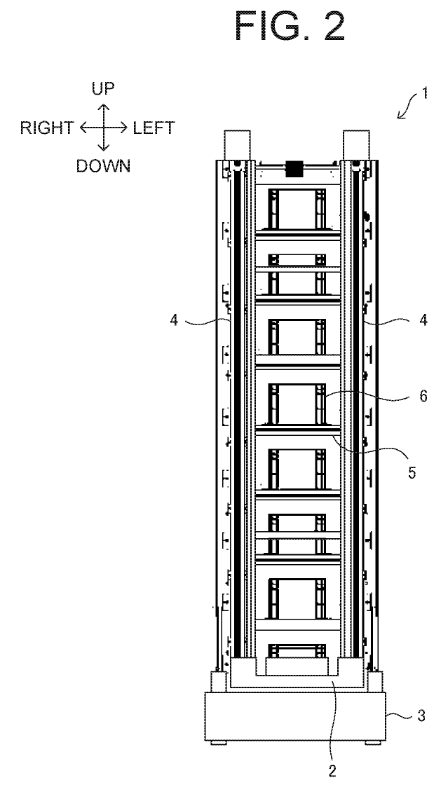

FIG. 1 is a side view illustrating an entire configuration of an automatic transport device 1 according to an embodiment of the present disclosure, and FIG. 2 is a front view illustrating the entire configuration of the automatic transport device 1. The automatic transport device 1 is, for example, an automatic guided vehicle that can travel in unmanned operation and includes a traveling section 3, a stock shelf 5 that stocks a transport target object 6, and a transfer device 2 that loads and unloads the transport target object 6 into and from the stock shelf 5.

The stock shelf 5 is an accommodation shelf capable of accommodating a transport target object transported by the automatic transport device 1. For example, the stock shelf 5 is mounted on and fixed to a top portion of the traveling section 3.

The traveling section 3 is capable of forward traveling, reverse traveling, and turning traveling. The traveling section 3 enables the automatic transport device 1 to travel along a traveling route from a current position to a target position (a storage shelf or the like) based on a transport request received by a server (not illustrated), for example. The automatic transport device 1 autonomously travels along the traveling route set in advance based on the transport request, picks the transport target object 6 from the storage shelf, and transports the transport target object 6 to a target position (a shipping area or the like). Note that a traveling method of the automatic transport device 1 is not particularly limited, and a traveling method, such as guide traveling in which the automatic transport device 1 travels while detecting a magnetic tape provided on a floor surface or guideless traveling in which the automatic transport device 1 travels along a traveling route while estimating a self-position, may be applied.

The top portion of the traveling section 3 has the stock shelf 5 and the transfer device 2 movable in a vertical direction. Specifically, a lifting and lowering device 4 is mounted on a top panel of the traveling section 3, and the lifting and lowering device 4 can move the transfer device 2 to a predetermined height by controlling lifting and lowering. Although not illustrated, the lifting and lowering device 4 includes a lifting and lowering rail and a lifting and lowering motor. When acquiring a transport request for transporting the transport target object 6, the lifting and lowering device 4 moves (lifts or lowers) the transfer device 2 to a height of a storage shelf that stores the transport target object 6.

The transfer device 2, which is mounted on the automatic transport device 1 in a lifting/lowering available manner, picks the transport target object 6 from the storage shelf storing the transport target object 6, and stocks (moves) the transport target object 6 on (onto) the stock shelf 5. Note that the stock shelf 5 is disposed adjacent to the transfer device 2.

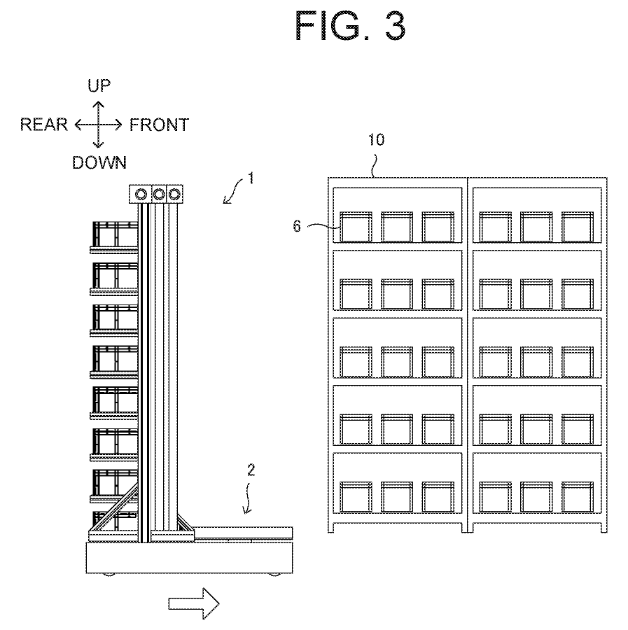

Here, an example of a procedure for moving the transport target object 6 onto the stock shelf 5 will be described. FIG. 3 is a diagram illustrating a storage shelf 10 storing the transport target object 6. Upon acquiring a transport request (picking command) for transporting the transport target object 6, the automatic transport device 1 automatically travels to the front of the storage shelf 10 storing the transport target object 6 in accordance with a traveling route set in advance.

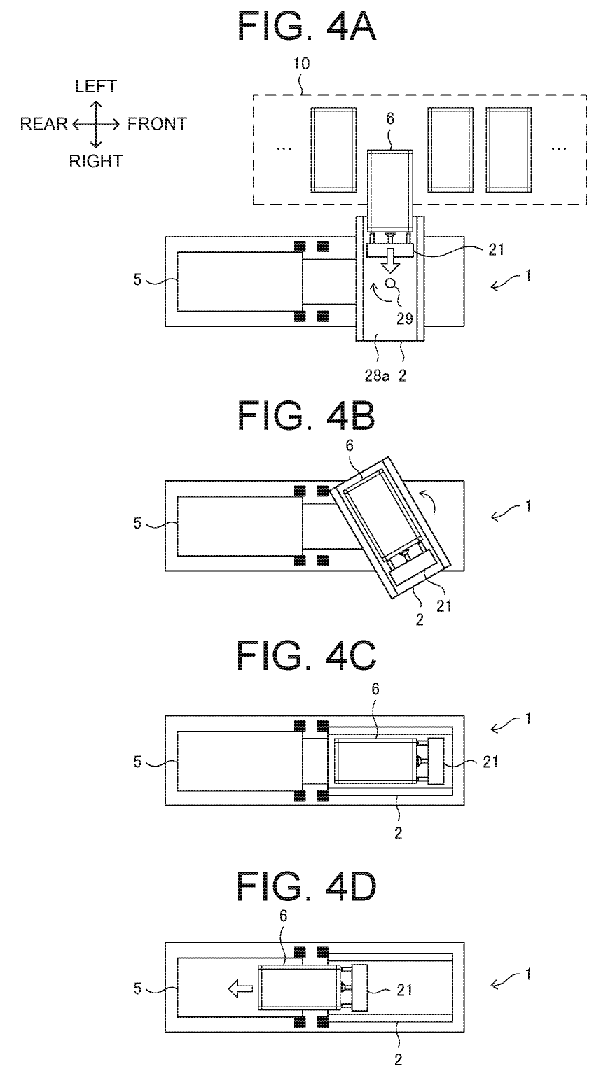

FIGS. 4A to 4D are diagrams schematically illustrating a procedure in which the transfer device 2 picks the transport target object 6 from the storage shelf 10 and moves the transport target object 6 onto the stock shelf 5 as viewed from above. First, when the automatic transport device 1 arrives in front of the storage shelf 10 and stops, the transfer device 2 moves (lifts or lowers) to a position of the shelf storing the transport target object 6 in accordance with an instruction of the lifting and lowering device 4. The lifting and lowering device 4 acquires position information pertaining to the transport target object 6 based on identification information on the transport target object 6 included in the transport request, and moves the transfer device 2 to the target position based on the position information. When arriving at the target position (height), the transfer device 2 rotates in a predetermined direction (for example, the clockwise direction) about a rotation shaft 29 (see FIG. 6). For example, when the automatic transport device 1 is positioned alongside the storage shelf 10 and stops, as illustrated in FIG. 4A, the transfer device 2 rotates clockwise by 90 degrees about the rotation shaft 29.

Thereafter, the transfer device 2 moves a coupler 21 toward the storage shelf 10 (leftward in FIGS. 4A to 4D), and couples the coupler 21 to a side surface of the transport target object 6. A specific coupling method will be described later. When the coupler 21 is coupled to the side surface of the transport target object 6, the transfer device 2 moves the coupler 21 in a direction opposite to the storage shelf 10 (rightward in FIGS. 4A to 4D), thereby sliding the transport target object 6 on a shelf plate of the storage shelf 10 and a slide surface 28a of the transfer device 2 and placing the transport target object 6 on the slide surface 28a (FIG. 4B).

Thereafter, the transfer device 2 rotates about the rotation shaft 29 in a predetermined direction (counterclockwise) by 90 degrees (see FIGS. 4B and 4C). Thereafter, the transfer device 2 moves (lifts or lowers) to a target stock position (empty space) of the stock shelf 5 in accordance with an instruction of the lifting and lowering device 4. When arriving at the target position (height), the transfer device 2 moves the coupler 21 toward the stock shelf 5 (a rearward direction in FIGS. 4A to 4D), thereby sliding the transport target object 6 on the slide surface 28a and pushing the transport target object 6 into the stock shelf 5 (see FIG. 4D). In this way, the transfer device 2 picks the transport target object 6 from the storage shelf 10 and moves the transport target object 6 onto the stock shelf 5.

When picking the transport target object 6 stocked on the stock shelf 5, the transfer device 2 performs a reverse operation of the above-described procedure.

### Transfer Device 2

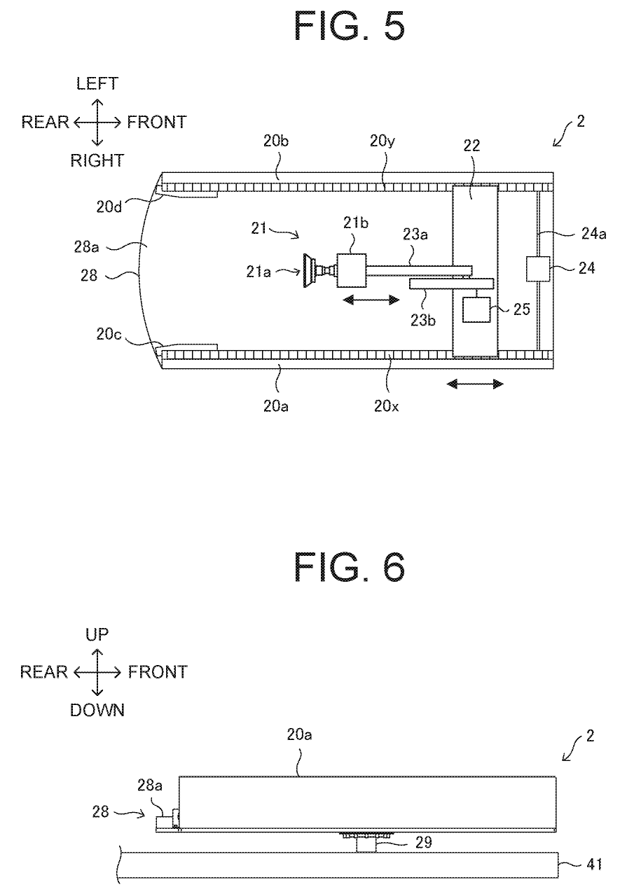

A specific configuration of the transfer device 2 that picks the transport target object 6 will be described. FIG. 5 is a top view of the transfer device 2, and FIG. 6 is a side view of the transfer device 2.

The transfer device 2 includes a holder 28 (bottom plate), side walls 20a and 20b rising upward from the holder 28, a rail 20x provided on the side wall 20a, a rail 20y provided on the side wall 20b, a base 22 connected to the rails 20x and 20y, an extendable mechanism 23 (arms 23a and 23b) connected to the base 22, the coupler 21 connected to the extendable mechanism 23, drive motors 24 and 25, and the rotation shaft 29 rotatably supporting the transfer device 2 with respect to a support portion 41 (see FIG. 6). The support portion 41 is a constituent member of the lifting and lowering device 4 and is movable in the vertical direction by means of the lifting and lowering device 4. The transfer device 2 is mounted on the support portion 41 and is rotatable in a horizontal direction about the rotation shaft 29.

The holder 28 includes the slide surface 28a. The holder 28 holds the transport target object 6 so that the transport target object 6 can slide in a front-rear direction (a first direction in the present disclosure) on the slide surface 28a. The slide surface 28a may be composed of a plurality of roller members, or may be composed of a board member made of a material (resin or the like) enabling an article to slide thereon.

The side wall 20a is provided at a right end of the transfer device 2, and the side wall 20b is provided at a left end of the transfer device 2. A space in which the transport target object 6 can be loaded and unloaded is formed between the side walls 20a and 20b. In addition, guides 20c and 20d serving as guide members when the transport target object 6 enters the space are provided at rear ends of the side walls 20a and 20b, respectively.

The rail 20x extending in the front-rear direction is provided inside the side wall 20a, and the rail 20y extending in the front-rear direction is provided inside the side wall 20b. Specifically, the rails 20x and 20y are disposed on opposite end sides of the slide surface 28a in the left-right direction (a second direction in the present disclosure).

The base 22 is connected to the rails 20x and 20y so as to be movable in the front-rear direction above the slide surface 28a. To be specific, as illustrated in FIG. 5, the right end portion of the base 22 is connected to the rail 20x, and the left end portion of the base 22 is connected to the rail 20y. The base 22 is movable in the front-rear direction on the rails 20x and 20y. The drive motor 24 slides the base 22 in the front-rear direction on the rails 20x and 20y. For example, the drive motor 24 includes a rotation shaft 24a connected to the rails 20x and 20y, and moves (rotates) the rails 20x and 20y or a rotation belt (not illustrated) disposed along the rails 20x and 20y in the front-rear direction by rotating the rotation shaft 24a. The base 22 moves in the front-rear direction in accordance with a movement operation of the rails 20x and 20y or the rotation belt driven by the drive motor 24. As described above, the rails 20x and 20y may include the rotation belt connected to the base 22, and the base 22 may be moved in the front-rear direction on the rails 20x and 20y in accordance with a rotation operation of the rotation belt driven by the drive motor 24. A mechanism for moving the base 22 in the front-rear direction is not limited to the above-described configuration, and a well-known mechanism including a pulley, a wheel, a belt, and the like may be applied.

The base 22 includes the drive motor 25 and the extendable mechanism 23. Specifically, the drive motor 25 is disposed on an upper surface of the base 22. One end of the extendable mechanism 23 is fixed to the upper surface of the base 22, and is connected to the drive motor 25. The extendable mechanism 23 is extendable outward from an end portion of the slide surface 28a on the rear side (see FIG. 5) and extendable in the front-rear direction. The drive motor 25 extends and contracts the extendable mechanism 23 in the front-rear direction.

For example, the extendable mechanism 23 includes the arms 23a and 23b. One end (a front end portion in FIG. 5) of the arm 23b is fixed to the upper surface of the base 22, and the other end (a rear end portion in FIG. 5) of the arm 23b extends rearward beyond the base 22. One end (a front end portion in FIG. 5) of the arm 23a is connected to the arm 23b so as to be movable in the front-rear direction, and the coupler 21 is connected to the other end (a rear end portion in FIG. 5) of the arm 23a.

In this way, the extendable mechanism 23 is configured such that the arm 23a is movable relative to the arm 23b. Therefore, the arm 23a can extend and contract in the front-rear direction by a length of the arm 23b in the front-rear direction. That is, the extendable mechanism 23 has a multi-stage telescopic mechanism capable of extending and contracting in the front-rear direction. Although a two-stage telescopic mechanism is illustrated in this embodiment, the transfer device 2 according to the present disclosure may include a three or more-stage telescopic mechanism.

For example, the drive motor 25 rotates a rotation belt connected to the arm 23b to move (extend and contract) the arm 23a in the front-rear direction relative to the arm 23b.

As described above, in the transfer device 2, the drive motor 24 moves the base 22 in the front-rear direction on the slide surface 28a, and the drive motor 25 extends and contracts the extendable mechanism 23 in the front-rear direction on the base 22.

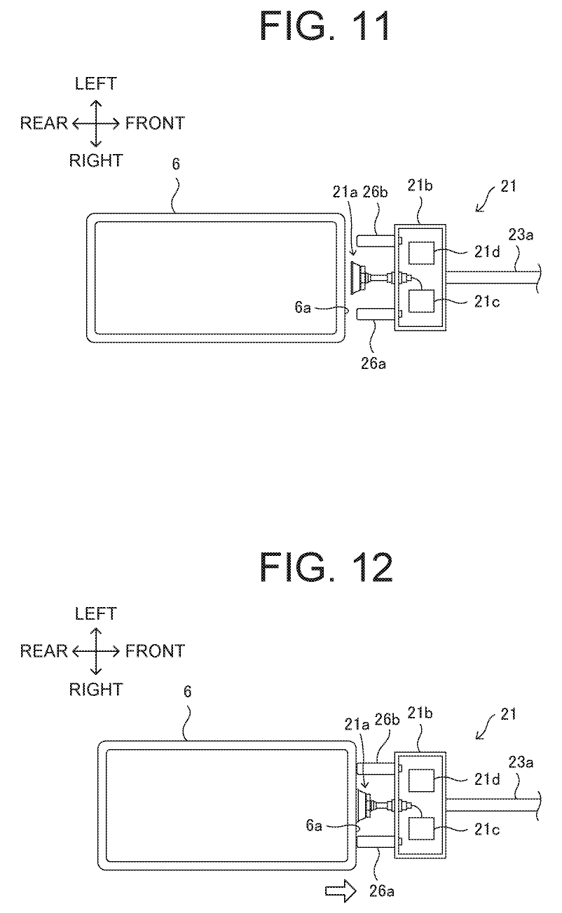

The coupler 21 provided in a distal end of the extendable mechanism 23 is coupled to the side surface of the transport target object 6. Specifically, the coupler 21 includes a suction head 21a that holds the side surface of the transport target object 6 by suction, and a suction unit 21b that is disposed at a distal end in the front-rear direction of the extendable mechanism 23 and applies a suction force to the suction head 21a. The suction head 21a holds the side surface of the transport target object 6 by a suction force (negative pressure) applied by the suction unit 21b. Note that the suction unit 21b includes a vacuum pump 21c (see FIGS. 11 and 12) for sucking the air in the suction head 21a, and the vacuum pump 21c sucks and discharges the air in an internal space of a suction cup of the suction head 21a. For example, when the vacuum pump 21c is driven, the air in a suction cup is sucked, so that the suction cup adheres to the object (the transport target object 6).

A signal cable (not illustrated) is connected to the coupler 21. The signal cable is composed of a flexible cable and is deformable in response to a movement of the coupler 21. The signal cable is connected to the suction unit 21b and transmits a control signal to the suction unit 21b. Based on the control signal, the suction unit 21b drives the drive motor 25 to control suction and discharge of the air performed by the vacuum pump 21c.

The rotation shaft 29 (see FIG. 6) disposed on a bottom surface of the transfer device 2 is connected to the support portion 41, and the support portion 41 lifts and lowers in accordance with an instruction of the lifting and lowering device 4. The transfer device 2 moves in the vertical direction along with a lifting and lowering operation of the support portion 41, and also rotary moves in a horizontal direction about the rotation shaft 29 on the support portion 41.

In this manner, in the transfer device 2, the side walls 20a and 20b and rails 20x and 20y are provided at opposite ends of the slide surface 28a in a direction orthogonal to the sliding direction, and the coupler 21 and the base 22 move in the front-rear direction (a direction of arrows in FIG. 5) between the side walls 20a and 20b in a state where the transport target object 6 is held by suction. Furthermore, the transfer device 2 slides the transport target object 6 on the slide surface 28a in a state in which the coupler 21 is coupled to the side surface of the transport target object 6. Furthermore, the extendable mechanism 23 is connected to the base 22 and has a structure (telescopic mechanism) capable of extending outward from the base 22.

### Picking Method

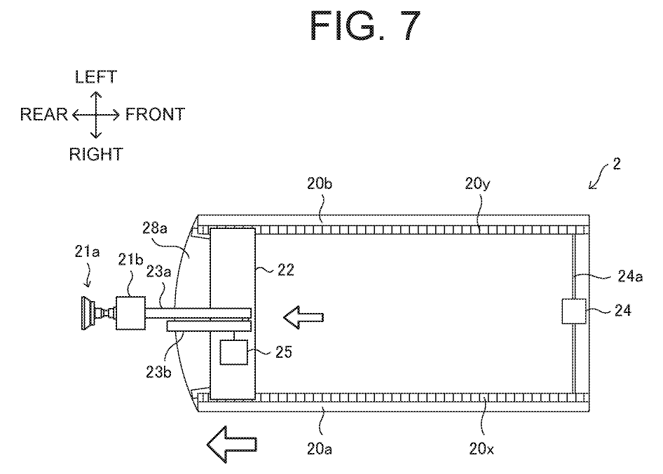

A specific example of a method of picking the transport target object 6 by the transfer device 2 will be described with reference to FIGS. 7 to 10. Here, an example in which the transfer device 2 picks the transport target object 6 from the storage shelf 10 (refer to FIG. 3) and moves the transport target object 6 onto the slide surface 28a of the holder 28 is illustrated.

First, when arriving at a position of the intended transport target object 6, as illustrated in FIG. 7, the transfer device 2 drives the drive motor 24 to move the base 22 to an end portion (rear end portion) of the slide surface 28a. At this time, the extendable mechanism 23 maintains the arm 23a at a right end position (maintains a first posture) so that an extendable length becomes the shortest.

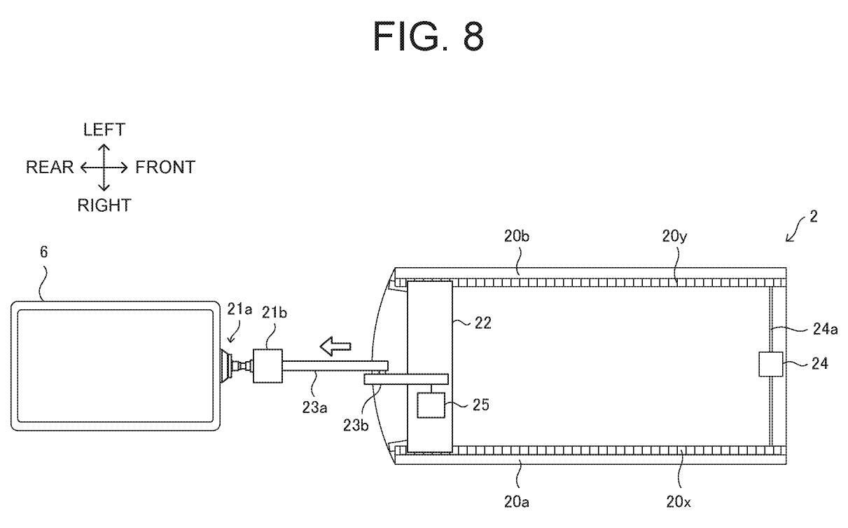

Subsequently, as illustrated in FIG. 8, the transfer device 2 drives the drive motor 25 of the base 22 to extend the extendable mechanism 23. To be specific, the transfer device 2 extends the arm 23a outward (in a direction of an arrow in FIG. 8) until the suction head 21a comes into contact with the transport target object 6. When the suction head 21a comes into contact with the transport target object 6, the transfer device 2 drives the suction unit 21b to cause the suction head 21a to hold the side surface of the transport target object 6 by suction. Thus, the transport target object 6 is held by the suction head 21a.

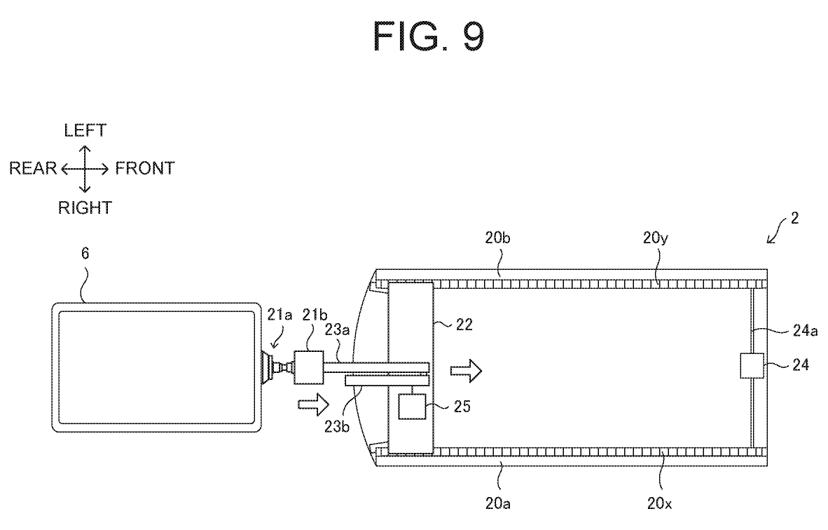

After the suction head 21a holds the transport target object 6 by suction, the transfer device 2 drives the drive motor 25 to contract the extendable mechanism 23. Specifically, as illustrated in FIG. 9, the transfer device 2 moves the arm 23a to the right end position and returns the arm 23a to the position of the first posture. The transfer device 2 slides the transport target object 6 on the shelf plate of the storage shelf 10 while moving the arm 23a.

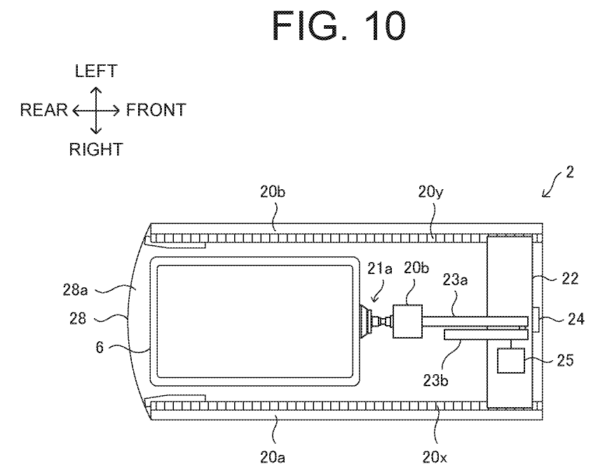

When the arm 23a takes the first posture, as illustrated in FIG. 10, the transfer device 2 drives the drive motor 24 to move the base 22 to the end portion (front end portion) of the slide surface 28a while maintaining the first posture. The transfer device 2 slides the transport target object 6 on the slide surface 28a while moving the base 22. Consequently, the transport target object 6 is pulled by the suction head 21a and slides forward on the slide surface 28a.

As described above, the transfer device 2 moves the base 22 on the slide surface 28a (see FIG. 7) and moves the coupler 21 in the base 22 in a direction away from the slide surface 28a in accordance with the operation of the extendable mechanism 23 (see FIG. 8).

According to the above configuration, the transport target object 6 can be picked by the suction head 21a and moved onto the slide surface 28a of the holder 28. Furthermore, since the suction head 21a can be extended to a distant place by the extension/contraction mechanism of the extendable mechanism 23, the transport target object 6 can be reliably picked even in a case where the transport target object 6 is disposed (stored) at a position distant from the slide surface 28a.

When the transport target object 6 placed on the slide surface 28a is moved to the storage (the storage shelf 10 or the stock shelf 5), the coupler 21 performs an operation of pushing the transport target object 6 outward (rearward).

For example, in a state where the suction head 21a holds the side surface of the transport target object 6 by suction, the base 22 moves rearward by being driven by the drive motor 24 and pushes the transport target object 6 rearward from the slide surface 28a. Furthermore, the coupler 21 further pushes out the transport target object 6 by the arm 23a extending outward due to the driving of the drive motor 25. As a result, the transport target object 6 is slid and accommodated in the storage.

As described above, the automatic transport device 1 of this embodiment transports the transport target object 6 to a predetermined location. Furthermore, the automatic transport device 1 includes the holder 28 that includes the slide surface 28a and holds the transport target object 6 so as to be slidable in the first direction (the front-rear direction illustrated in FIG. 5) on the slide surface 28a, and the rails 20x and 20y disposed on the slide surface 28a, the base 22 connected to the rails 20x and 20y so as to be movable in the first direction above the slide surface 28a, the drive motor 24 (first driver) that slides the base 22 along the rails 20x and 20y, the extendable mechanism 23 (arms 23a and 23b) that is disposed on the base 22 and is extendable outward from the end portion (rear end portion illustrated in FIG. 5) in the first direction of the slide surface 28a and is extendable in the first direction, and the coupler 21 that is disposed at the distal end of the extendable mechanism 23 and is coupled to the side surface of the transport target object 6. Furthermore, the extendable mechanism 23 has a multi-stage telescopic mechanism capable of extending and contracting in the first direction.

In addition, in the automatic transport device 1, the rails 20x and 20y are disposed on opposite end sides of the slide surface 28a in a second direction (left-right direction illustrated in FIG. 5) orthogonal to the first direction. The base 22 is connected to the rails 20x and 20y, and the extendable mechanism 23 is disposed in a region between the rails 20x and 20y. For example, the extendable mechanism 23 is disposed in a central portion between the rails 20x and 20y. The extendable mechanism 23 is narrower in the second direction than the slide surface 28a. As a result, the extendable mechanism 23 can access a region narrower than a width of the slide surface 28a.

Furthermore, the coupler 21 includes the suction head 21a that holds the side surface of the transport target object 6 by suction, and the suction unit 21b that applies a suction force to the suction head 21a is disposed at the distal end in the front-rear direction of the extendable mechanism 23. That is, the coupler 21 and the suction unit 21b move in the first direction together with the base 22, and move in the first direction together with the arm 23a in accordance with the expansion and contraction of the extendable mechanism 23. The suction unit 21b may include the vacuum pump 21c for sucking the air in the suction head 21a.

In addition, the automatic transport device 1 includes the drive motor 25 (second driver) which expands and contracts the extendable mechanism 23 in the first direction. Furthermore, the drive motor 24 is disposed in the holder 28, and the drive motor 25 is disposed in the base 22. The drive motor 24 moves the base 22 in the first direction on the rails 20x and 20y. The drive motor 25 can expand and contract the extendable mechanism 23 independently of the movement operation of the base 22.

In the automatic transport device 1, for example, after the drive motor 24 moves the base 22 to the end portion of the slide surface 28a in the first direction (refer to FIG. 7), the drive motor 25 extends the extendable mechanism 23 in the first direction (refer to FIG. 8).

In addition, the automatic transport device 1 includes the traveling section 3. The traveling section 3 causes the automatic transport device 1 to automatically travel along a traveling route to a target position (a storage shelf or the like).

According to the configuration of this embodiment, the transport target object 6 can be stably held and transported since the transport target object 6 slides on the slide surface 28a, and a transport stroke length of the transport target object 6 can be increased toward the outer side of the slide surface 28a. In addition, while the side surface of the transport target object 6 is held, the transport target object 6 can be transported such that the transport target object 6 is slid on the shelf plate of the storage shelf 10 outside the slide surface 28a and is slid on the slide surface 28a inside the holder 28.

Furthermore, by combining the two rails 20x and 20y disposed on the opposite sides of the slide surface 28a and the extendable mechanism 23 disposed on the base 22 connected to the rails 20x and 20y, a width of the extendable mechanism 23 in the left-right direction may be narrower and the slide operation may be stably performed. Note that, since the narrow width of the extendable mechanism 23 and its stability (that is, the strength of the arms 23a and 23b) are in a trade-off relationship, a proximal portion of the extendable mechanism 23 is configured as the base 22 that is connected to the two rails 20x and 20y to increase stability, while a distal portion thereof is configured as the extendable mechanism 23 having a narrow width.

Furthermore, according to the above-described configuration, since the width of the coupler 21 in the left-right direction is narrow and the transport target object 6 is coupled by suction, for example, even when a plurality of transport target objects 6 are arranged close to each other in the left-right direction, only an intended one of the transport target objects 6 can be picked without coming into contact with the adjacent transport target objects 6.

### Other Embodiments

As another embodiment of the present disclosure, as illustrated in FIGS. 11 and 12, the coupler 21 may include a contact member 26 that comes into contact with a side surface 6a of the transport target object 6. In a state before the suction head 21a holds the transport target object 6 by suction (see FIG. 11), a protruding length of the suction head 21a from the distal end of the suction unit 21b is longer than that of the contact member 26. In a state where the suction head 21a holds the transport target object 6 by suction (see FIG. 12), the protruding length of the suction head 21a is equal to the protruding length of the contact member 26, whereby the contact member 26 comes into contact with the side surface 6a of the transport target object 6.

Specifically, the coupler 21 includes the suction head 21a, the contact member 26, the vacuum pump 21c, and the drive motor 21d.

The suction head 21a holds a central portion of the side surface 6a of the transport target object 6 by suction. Specifically, the suction head 21a includes the suction cup and a shaft portion, and is fixed to a main body frame of the suction unit 21b. For example, the shaft portion penetrates a side wall of the main body frame and is movable in the front-rear direction. The suction cup is disposed at a distal end of the shaft portion, and has an extendable and contractible bellows structure. That is, the suction head 21a is disposed so that a suction cup side protrudes from the main body frame. Internal spaces are formed inside the suction cup and the shaft portion, and the air in the internal spaces is drawn in and discharged by the vacuum pump 21c. Consequently, for example, when the vacuum pump 21c is driven, the air in the suction cup is sucked, so that the suction cup adheres to the object (the transport target object 6).

The contact member 26 is fixed to the main body frame. In this embodiment, a right contact member 26a and a left contact member 26b are exemplified, but the number of the contact members 26 is not limited and may be one or three or more. For example, the suction head 21a is provided at a central portion of the main body frame, the contact member 26a is provided on the right side of the main body frame, and the contact member 26b is provided on the left side of the main body frame. Each of the contact members 26a and 26b has one end fixed to the main body frame and the other end that protrudes from the main body frame. The contact members 26a and 26b have the same length (protruding length). Furthermore, as illustrated in FIG. 11, in a state where the suction head 21a does not adhere to the transport target object 6, a protruding length of the suction head 21a is longer than the protruding length of the contact members 26a and 26b. That is, in a state where the suction head 21a does not adhere to the transport target object 6, the suction head 21a protrudes further to the rear side (see FIG. 11) than the contact members 26a and 26b. A cushioning material (rubber or the like) may be provided at distal ends of the contact members 26a and 26b so as not to be damaged when coming into contact with the transport target object 6.

In a case where the transfer device 2 picks up the transport target object 6, when the coupler 21 moves and the suction cup of the suction head 21a comes into contact with the side surface 6a of the transport target object 6, the vacuum pump 21c is driven by the drive motor 21d. Accordingly, the air in the suction cup is sucked, so that the suction cup adheres to the side surface 6a by suction (see FIG. 12). Here, when the vacuum pump 21c further sucks the air in the suction cup, the suction cup contracts, and the transport target object 6 moves forward or the coupler 21 moves rearward in accordance with the deformation of the suction cup, so that the contact members 26a and 26b come into contact with the side surface 6a of the transport target object 6 (see FIG. 12).

In this manner, in the state before the suction head 21a holds the transport target object 6 by suction (refer to FIG. 11), the protruding length from the main body frame of the suction head 21a is longer than those of the contact members 26a and 26b. Therefore, when the suction head 21a adheres to the transport target object 6 and the protruding length of the suction head 21a becomes equal to the protruding lengths of the contact members 26a and 26b, the contact members 26a and 26b come into contact with the side surface 6a of the transport target object 6.

In the above configuration, the transport target object 6 is held, by the suction operation performed by the vacuum pump 21c, at three points, that is, the suction head 21a and the contact members 26a and 26b. Therefore, since the transport target object 6 can be held by the suction head 21a and the contact members 26a and 26b, the transport target object 6 can be stably slid.

### Appendices

An outline of the disclosure derived from the above embodiments will be described below as appendices. Note that the configurations and processing functions appended and described below can be selected and combined arbitrarily.

### Appendix 1

An automatic transport device that transports a transport target object to a predetermined location, the automatic transport device comprising:

a holder that has a slide surface and holds the transport target object on the slide surface so as to be slidable in a first direction;

a rail disposed on the slide surface;

a base connected to the rail so as to be movable in the first direction above the slide surface;

a first driver that slides the base along the rail;

an extendable mechanism that is disposed on the base and that is extendable outward from an end portion of the slide surface in the first direction and extendable in the first direction; and

a coupler that is disposed at a distal end of the extendable mechanism and coupled to a side surface of the transport target object.

### Appendix 2

The automatic transport device according to Appendix 1, wherein

the rail includes a first rail and a second rail arranged at opposite ends of the slide surface in a second direction orthogonal to the first direction,

the base is connected to the first rail and the second rail, and

the extendable mechanism is disposed in a region between the first rail and the second rail.

### Appendix 3

The automatic transport device according to Appendix 1 or 2, wherein

a width of the extendable mechanism in a second direction orthogonal to the first direction is smaller than a width of the slide surface in the second direction.

### Appendix 4

The automatic transport device according to any one of Appendices 1 to 3, wherein

the coupler includes a suction head that holds a side surface of the transport target object by suction, and

a suction unit that applies a suction force to the suction head is disposed at a distal end of the extendable mechanism in the first direction.

### Appendix 5

The automatic transport device according to Appendix 4, wherein

the suction unit includes a pump that sucks the air in the suction head.

### Appendix 6

The automatic transport device according to any one of Appendices 1 to 5, comprising:

a second driver that expands and contracts the extendable mechanism in the first direction.

### Appendix 7

The automatic transport device according to any one of Appendices 1 to 6, wherein

the first driver moves the base in the first direction on the first rail and the second rail.

### Appendix 8

The automatic transport device according to Appendix 6 or 7, wherein

the first driver is disposed on the holder, and

the second driver is disposed on the base.

### Appendix 9

The automatic transport device according to any one of Appendices 6 to 8, wherein

after the first driver moves the base to an end portion of the slide surface in the first direction, the second driver extends the extendable mechanism in the first direction.

### Appendix 10

The automatic transport device according to Appendices 1 to 9, wherein

the extendable mechanism includes a multi-stage telescopic mechanism which is extendable in the first direction.

### Appendix 11

The automatic transport device according to any one of Appendices 1 to 10, further comprising:

a traveling section that causes the automatic transport device to travel.

### Appendix 12

The automatic transport device according to Appendix 4, comprising:

a contact member that comes into contact with a side surface of the transport target object, wherein

in a state before the suction head holds the transport target object by suction, a protruding length of the suction head from a distal end of the suction unit is longer than a protruding length of the contact member from the distal end of the suction unit, and

in a state where the suction head holds the transport target object by suction, the protruding length of the suction head is equal to the protruding length of the contact member so that the contact member comes into contact with the side surface of the transport target object.

### Appendix 13

The automatic transport device according to any one of Appendices 1 to 12, comprising:

a transfer device that includes the holder, the rail, the base, the extendable mechanism, and the coupler and that is disposed on the automatic transport device so as to be movable up and down; and

a storage that stores the transport target object and that is disposed adjacent to the transfer device.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An automatic transport device that transports a transport target object to a predetermined location, the automatic transport device comprising:
a holder that has a slide surface and holds the transport target object on the slide surface so as to be slidable in a first direction;
a rail disposed on the slide surface;
a base connected to the rail so as to be movable in the first direction above the slide surface;
a first driver that slides the base along the rail;
an extendable mechanism that is disposed on the base and that is extendable outward from an end portion of the slide surface in the first direction and extendable in the first direction; and
a coupler that is disposed at a distal end of the extendable mechanism and coupled to a side surface of the transport target object.

2. The automatic transport device according to claim 1, wherein
the rail includes a first rail and a second rail arranged at opposite ends of the slide surface in a second direction orthogonal to the first direction,
the base is connected to the first rail and the second rail, and
the extendable mechanism is disposed in a region between the first rail and the second rail.

3. The automatic transport device according to claim 1, wherein
a width of the extendable mechanism in a second direction orthogonal to the first direction is smaller than a width of the slide surface in the second direction.

4. The automatic transport device according to claim 1, wherein
the coupler includes a suction head that holds a side surface of the transport target object by suction, and
a suction unit that applies a suction force to the suction head is disposed at the distal end of the extendable mechanism in the first direction.

5. The automatic transport device according to claim 4, wherein
the suction unit includes a pump that sucks the air in the suction head.

6. The automatic transport device according to claim 1, comprising:
a second driver that expands and contracts the extendable mechanism in the first direction.

7. The automatic transport device according to claim 2, wherein
the first driver moves the base in the first direction on the first rail and the second rail.

8. The automatic transport device according to claim 6, wherein
the first driver is disposed on the holder, and
the second driver is disposed on the base.

9. The automatic transport device according to claim 6, wherein
after the first driver moves the base to an end portion of the slide surface in the first direction, the second driver extends the extendable mechanism in the first direction.

10. The automatic transport device according to claim 1, wherein
the extendable mechanism includes a multi-stage telescopic mechanism which is extendable in the first direction.

11. The automatic transport device according to claim 1, further comprising:
a traveling section that causes the automatic transport device to travel.

12. The automatic transport device according to claim 4, comprising:
a contact member that comes into contact with a side surface of the transport target object, wherein
in a state before the suction head holds the transport target object by suction, a protruding length of the suction head from a distal end of the suction unit is longer than a protruding length of the contact member from the distal end of the suction unit, and
in a state where the suction head holds the transport target object by suction, the protruding length of the suction head is equal to the protruding length of the contact member so that the contact member comes into contact with the side surface of the transport target object.

13. The automatic transport device according to claim 1, comprising:
a transfer device that includes the holder, the rail, the base, the extendable mechanism, and the coupler and that is disposed on the automatic transport device so as to be movable up and down; and
a storage that stores the transport target object and that is disposed adjacent to the transfer device.
